(19) United States
(12) Patent Application Publication
(10) Pub. No.: US 2025/0231062 A1
(43) Pub. Date: Jul. 17, 2025

(54) PROCESSING APPARATUS, OPTICAL MEASUREMENT APPARATUS, OPTICAL MEASUREMENT METHOD, AND NON-TRANSITORY STORAGE MEDIUM STORING OPTICAL MEASUREMENT PROGRAM

(71) Applicant: KABUSHIKI KAISHA TOSHIBA, Tokyo (JP)

(72) Inventors: Kenta TAKANASHI, Kawasaki Kanagawa (JP); Hiroshi OHNO, Tokyo (JP); Hiroya KANO, Kawasaki Kanagawa (JP); Hideaki OKANO, Yokohama Kanagawa (JP)

(73) Assignee: KABUSHIKI KAISHA TOSHIBA, Tokyo (JP)

(21) Appl. No.: 19/007,488

(22) Filed: Jan. 1, 2025

(30) Foreign Application Priority Data
Jan. 11, 2024 (JP) 2024-002787

(51) Int. Cl. G01J 3/10; G01J 3/28

(52) U.S. Cl. CPC G01J 3/108; G01J 3/2823; G01J 2003/102; G01J 2003/2826; G01J 2003/2836; G01J 2003/284

(57) ABSTRACT

According to the embodiment, a processing apparatus includes a processor. The processor is configured to: cause a plurality of different projection lights to be projected onto an object, the projection lights respectively including a plurality of wavelengths different from each other; cause intensity values of the plurality of wavelengths to be acquired from the object for each of the projection lights, as intensity values of detection signals having no information regarding position at a stage of processing signals; transform numerical values of the intensity values of the detection signals using independent parameters for each of wavelengths to first transformed signals corresponding to the plurality of wavelengths from the object; and cause an image of the object to be acquired by the first transformed signals corresponding to the plurality of wavelengths from the object and signals related to the projection lights.

### CROSS-REFERENCE TO RELATED APPLICATIONS

This application is based upon and claims the benefit of priority from Japanese Patent Application No. 2024-002787, filed Jan. 11, 2024, the entire contents of all of which are incorporated herein by reference.

### FIELD

Embodiments described herein relate generally to a processing apparatus, an optical measurement apparatus, an optical measurement method, and a non-transitory storage medium storing an optical measurement program.

### BACKGROUND

Ghost imaging (hereinafter, abbreviated as GI) has high detection sensitivity, but is generally considered to take time to measure. Therefore, in a case where quick measurement is required like real-time inspection of an object, speed-up of GI is a problem. As a response to the speed-up of GI, utilization of the GI that simultaneously acquires signals of a plurality of wavelengths can be indicated.

### BRIEF DESCRIPTION OF DRAWINGS

FIG. 1 is a schematic view illustrating an optical measurement apparatus according to an embodiment.

FIG. 2 is a schematic view illustrating an example of a detector illustrated in FIG. 1.

FIG. 3 is a schematic view illustrating an example of the detector illustrated in FIG. 1 different from the detector illustrated in FIG. 2.

FIG. 4 is a schematic view illustrating an example of the detector illustrated in FIG. 1 different from the detectors illustrated in FIGS. 2 and 3.

FIG. 5 is a view illustrating a flow showing a state in which image reconstruction processing is performed using a conventional single-wavelength GI for a detection signal for each wavelength detected by sequentially projecting pattern lights including a plurality of wavelengths on a sample.

FIG. 6 is a schematic view illustrating a state in which, when multi-wavelength GI is used, after intensity of each wavelength from a light source of an illumination unit incident on the detector is measured, the intensity of each wavelength from the light source is adjusted and incident on the detector.

FIG. 7 is a schematic view illustrating a sample, a detection signal for each wavelength detected by sequentially projecting pattern lights including a plurality of wavelengths on the sample, and a transformed signal obtained by performing transformation processing on the detection signal, in a case where an image of the sample is reconstructed using the optical measurement apparatus according to an embodiment.

FIG. 8 is a schematic view illustrating a transformed signal illustrated in FIG. 7 and a reconstructed image obtained by performing reconstruction processing on the transformed signal, in the case where the image of the sample is reconstructed using the optical measurement apparatus according to an embodiment.

FIG. 9 illustrates a flow illustrating a series of processing from sequentially projecting pattern lights including a plurality of wavelengths on the sample to obtaining the image (reconstructed image) of the sample using the optical measurement apparatus according to an embodiment.

### DETAILED DESCRIPTION

Hereinafter, an optical measurement apparatus 10 according to the present embodiment will be described with reference to the drawings. The drawings are schematic or conceptual, and a relationship between a thickness and a width of each portion, a size ratio between portions, and the like are not necessarily the same as actual ones. In addition, even the same portion may be represented in the drawings differently in dimensions and ratios. Detailed description of the contents already described will be omitted as appropriate.

It is an object of an embodiment to provide a processing apparatus, an optical measurement apparatus, an optical measurement method, and a non-transitory storage medium storing an optical measurement program, which are configured to cause a plurality of wavelengths to be projected onto an object and to cause an image of the object to be acquired from a detection signal of each of light intensity.

According to the embodiment, a processing apparatus includes a processor. The processor is configured to: cause a plurality of different projection lights to be projected onto an object, the projection lights respectively including a plurality of wavelengths different from each other; cause intensity values of the plurality of wavelengths to be acquired from the object for each of the projection lights, as intensity values of detection signals having no information regarding position at a stage of processing signals; transform numerical values of the intensity values of the detection signals using independent parameters for each of wavelengths to first transformed signals corresponding to the plurality of wavelengths from the object; and cause an image of the object to be acquired by the first transformed signals corresponding to the plurality of wavelengths from the object and signals related to the projection lights.

In the present embodiment, light is defined as an electromagnetic wave. The light is, for example, visible light, an X-ray, an ultraviolet ray, an infrared ray, a near infrared ray, a far infrared ray, or a microwave. A light source of an illumination unit 12 may emit any of visible light, ultraviolet rays, and infrared rays, for example. The visible light is light having a wavelength of, for example, 420 nm or more and 760 nm or less.

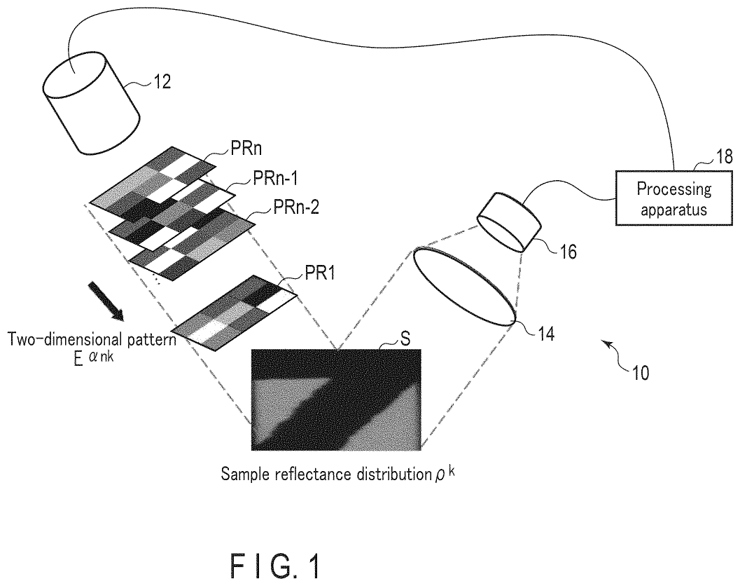

FIG. 1 illustrates a configuration diagram of an optical measurement apparatus 10 for ghost imaging (hereinafter, referred to as GI) according to the present embodiment.

As illustrated in FIG. 1, the optical measurement apparatus 10 for the GI according to the present embodiment includes: an illumination unit 12 configured to project a plurality of two-dimensional pattern lights E^{αnk} on a sample (object) S; an optical element (lens) 14 configured to pass transmitted light of the sample S or reflected light from the sample S when the two-dimensional pattern lights E^{αnk} are projected on the sample S; a detector 16 configured to detect intensity of the transmitted light or reflected light having passed through the optical element 14; and a processing apparatus (optical processing apparatus) 18 configured to process a signal.

The light source of the illumination unit 12 is, for example, a light-emitting diode (LED). A projector may be used as the illumination unit 12. The illumination unit 12 irradiates a surface of the sample S with two-dimensional pattern light. The illumination unit 12 can emit a plurality of light beams having wavelengths different from each other. In the present embodiment, the illumination unit 12 can emit light beams having at least two wavelengths (for example, a first light beam having a first wavelength, a second light beam having a second wavelength, and a third light beam having a third wavelength). In an example, the first wavelength is, for example, 450 nm (blue light), the second wavelength is, for example, 650 nm (red light), and the third wavelength is, for example, 550 nm (green light). In the present embodiment, the illumination unit 12 can simultaneously project illumination lights of three wavelengths (first wavelength, second wavelength, and third wavelength) onto the sample S. The illumination lights projected by the illumination unit 12 are pattern lights having two-dimensional patterns. Here, the two-dimensional patterns (pattern lights) of the illumination lights are lights with intensity of light having a distribution of different intensities depending on the position in a cross section orthogonal or substantially orthogonal to a propagation direction of the illumination lights. That is, the two-dimensional patterns of the illumination lights have spatial intensity distributions. The pattern lights projected by the illumination unit 12 includes at least two of lights of a first wavelength W1, a second wavelength W2, and a third wavelength W3 that are different from each other, and have different patterns from each other.

As illustrated in FIG. 1, the illumination unit 12 sequentially projects, for example, two or more two-dimensional pattern lights onto the sample S. After projecting first pattern light PR1 on the sample S, the illumination unit 12 sequentially projects second pattern light PR2, third pattern light PR3, . . . , and n-th pattern light PRn (n is a natural number of 2 or more) onto the sample S. The first pattern light PR1 to the n-th pattern light PRn have no correlation with each other. Here, n is preferably 3 or more.

The optical element (lens) 14 forms an image from, or condenses, transmitted light of the sample S or reflected light from the sample S on the detector 16, for example.

The optical measurement apparatus 10 for the GI involves sequentially projecting two-dimensional patterns (pattern lights PR1, PR2, . . . , PRn) including a plurality of wavelengths W1, W2, and W3 on the sample S, and detecting signal intensities n times for each of the plurality of wavelengths with the detector 16 having spectroscopic performance. Hereinafter, this is referred to as multi-wavelength GI. This multi-wavelength GI increases the number of signal intensities detected per detection by the number of wavelengths superimposed according to the number for the spectroscopic performance, and shortens the time required for the GI relative to that required for single-wavelength GI.

In the optical measurement apparatus 10 according to the present embodiment, for example, a single-pixel detector is used as the detector 16. Here, the single-pixel detector 16 refers to a detector that can detect lights of at least two different wavelengths as detection signals and does not have information regarding position at a stage of processing the detection signals. For example, a single detector such as a photodetector or a photomultiplier corresponds to this detector. The single-pixel detector 16 according to the present embodiment can receive intensity values of lights of a plurality of wavelengths from the sample S by projection of each of a plurality of two-dimensional pattern lights (projection lights) including at least two different wavelengths projected toward the sample (object) S, and the processing apparatus 18 causes at least two different wavelengths to be acquired by the single-pixel detector 16 as one set of detection signals having no information regarding position at a stage of processing each signal. The one set of detection signals is, for example, light intensity values of R, G, and B. Therefore, in the present embodiment, the detector 16 can acquire one set of light intensity values of R, G, and B as the at least two different wavelengths as the detection signals.

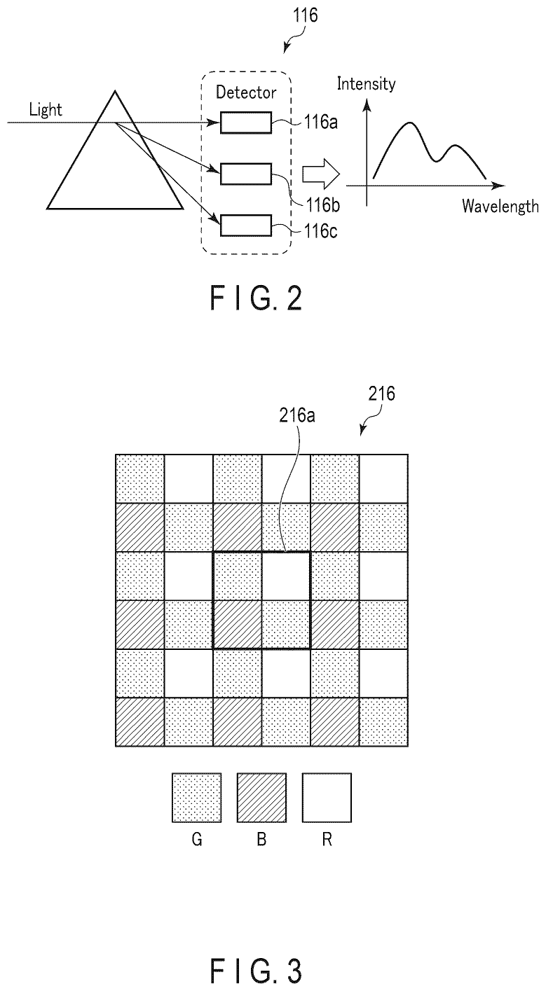

Furthermore, a general spectrometer 116 illustrated in FIG. 2 has a plurality of detectors 116a, 116b, and 116c arranged therein (inside the spectrometer 116). The spectrometer 116 can detect lights of at least two different wavelengths as detection signals. The detectors 116a, 116b, and 116c of the spectrometer 116 do not have information regarding position at the stage of signal processing by the processing apparatus 18, and thus may also be regarded as single-pixel detectors.

Similarly, FIG. 3 illustrates an image sensor 216 (color camera) in which a large number of pixels are arranged in a predetermined arrangement. An example of the image sensor 216 is a CMOS, a CCD, or the like. The image sensor 216 can detect lights of at least two different wavelengths as detection signals in each pixel. Even in a case where the processing apparatus 18 extracts one pixel in the image sensor 216 illustrated in FIG. 3 and uses signals acquired by the one pixel for processing, the pixel (one pixel) 216a can be processed as not including information of an array of color filters (Bayer layout) of the image sensor 216. Therefore, the image sensor 216 can be regarded as a single-pixel detector in a case where the one pixel 216a in the image sensor 216 is extracted and used by the processing apparatus 18.

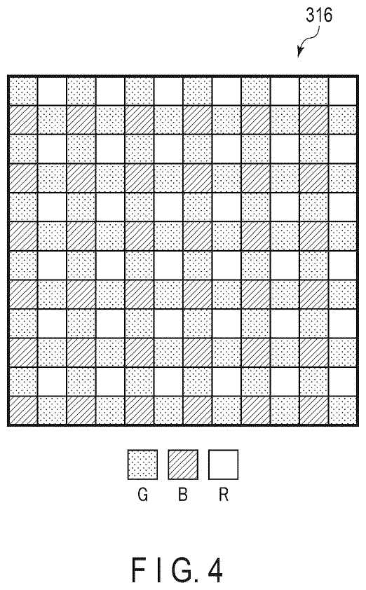

Further, FIG. 4 illustrates an image sensor 316 (color camera) in which a large number of pixels are arranged in a predetermined arrangement. An example of the image sensor 316 is a monochrome camera or a color camera. The image sensor 316 can detect lights of at least two different wavelengths as detection signals. Even for a spatial imaging element such as an image sensor (a monochrome camera or a color camera) 316 illustrated in FIG. 4, the processing apparatus 18 can calculate the sum of light intensity values of all pixels at the stage of signal processing, and can process the signals as not having the information regarding position, when processing the information acquired by the image sensor 316. In this case, the image sensor 316 can be treated as a single-pixel detector.

Hereinafter, the processing apparatus 18 will be described. The processing apparatus 18 is configured to control the light source of the illumination unit 12 and the detector 16. Furthermore, the processing apparatus 18 is configured to perform various arithmetic computations by signals related to a plurality of two-dimensional pattern lights (projection lights) emitted from the illumination unit 12 and a signal input from the detector 16 to the processing apparatus 18.

The processing apparatus 18 is composed, for example, of a computer, and includes a processor (processing unit) and a storage medium. The processor includes any of a central processing unit (CPU), an application specific integrated circuit (ASIC), a microcomputer, a field programmable gate array (FPGA), a digital signal processor (DSP), and the like. The storage medium may include a non-transitory auxiliary storage device in addition to a main storage device such as a memory. Examples of the storage medium include non-volatile memories capable of writing and reading at any time, such as a hard disk drive (HDD), a solid state drive (SSD), a magnetic disk, an optical disk (CD-ROM, CD-R, DVD, etc.), a magneto-optical disk (MO or the like), and a semiconductor memory.

In the processing apparatus 18, the number of each of the processor and the storage medium provided may be only one or two or more. In the processing apparatus 18, the processor performs processing by executing a program or the like stored in a storage medium or the like. Furthermore, the program executed by the processor of the processing apparatus 18 may be stored in a computer (server) connected to the processing apparatus 18 via a network such as the Internet, a server in a cloud environment, or the like. In this case, the processor downloads the program via the network.

Signal acquisition from the detector 16 and various types of calculation processing based on the signal acquired from the detector 16 and the signal related to the two-dimensional pattern lights (projection lights) from the illumination unit 12 in the processing apparatus 18 are executed by a processor or the like, and the storage medium functions as a data storage unit.

Furthermore, at least a part of the processing by the processing apparatus 18 may be executed by a cloud server configured in the cloud environment. An infrastructure of the cloud environment is composed of a virtual processor such as a virtual CPU and a cloud memory. In one example, signal acquisition from the detector 16 and various types of calculation processing based on the signal acquired from the detector 16 and the signal related to the two-dimensional pattern lights (projection lights) from the illumination unit 12 are executed by a virtual processor, and the cloud memory functions as a data storage unit.

Here, some variables are defined for the following description. In the optical measurement apparatus 10 for the multi-wavelength GI according to the present embodiment, the processing apparatus 18 controls the light source of the illumination unit 12 to irradiate the sample S with two-dimensional pattern lights (projection lights) having no correlation from the illumination unit 12, that is, measures the intensity values for each two-dimensional pattern lights with the detector 16 while changing the two-dimensional pattern light. The total number of measurements is defined as N. In addition, a random pattern of the two-dimensional pattern light projected from the illumination unit 12 in the n-th measurement is set as E^{αnk}. The subscript a corresponds to a wavelength, and the subscript k corresponds to each pixel of the two-dimensional pattern. The reflectance of the sample is represented as ρ^{αk}, and the signal intensity detected at the n-th time measurement by the detector 16 is represented as B^{αn}. This signal (detection signal intensity) B^{αn} is used for standardization processing (first transformation processing) which will be described later.

Note that the processing apparatus 18 synchronizes detection of the signal intensity B^{αn} of the detector 16 in response to irradiation of a certain two-dimensional pattern light E^{αnk}. Then, the processing apparatus 18 detects the signal intensity B^{αn} of the detector 16 in response to the irradiation of each two-dimensional pattern light E^{αnk}. The processing apparatus 18 receives from the illumination unit 12 what two-dimensional pattern light E^{αnk} has been projected from the illumination unit 12. This signal (two-dimensional pattern light) E^{αnk} is used for standardization processing (second transformation processing) which will be described later.

For a general function Ax that depends on a variable x, <Ax>x represents an average for the variable x of Ax. Specifically, when the variable x takes a value of a total number X such as x=x₁, x₂, x₃, . . . x_{X}, it can be expressed as Equation (1).

$${〈 {A}_{x} 〉}_{x} = \frac{1}{X} {\sum }_{x = {x}_{1}}^{{x}_{X}} {A}_{x} \qquad ( 1 )$$

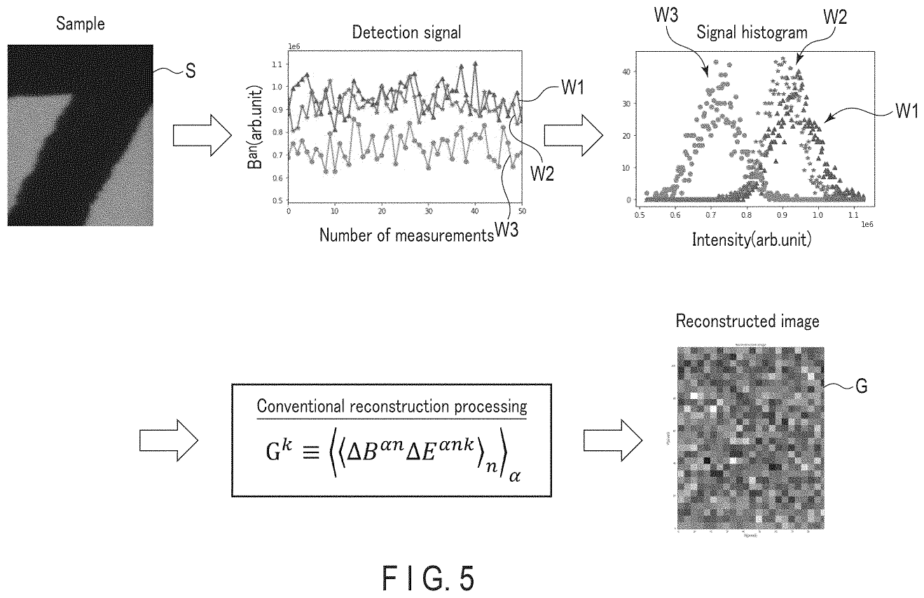

First, FIG. 5 illustrates an example of the signal intensity B^{αnk} acquired by the detector 16 in the multi-wavelength GI when the projection pattern light E^{αnk} using a random pattern including three wavelengths (W1, W2 and W3) is projected on the sample S, and a histogram of the signal intensity B^{αn} obtained from the example of the signal intensity B^{αn}. As can be seen from FIG. 5, in general, the detection signal intensity B^{αn} and the signal histogram have different distributions for each wavelength. This is because the detection signal intensity B^{αn} has a correlation with the wavelength due to the wavelength characteristics of light receiving elements of the illumination unit 12 and the detector 16. When the image is reconstructed in the multi-wavelength GI, in order to effectively utilize all the signal intensities B^{αn}, it is necessary to treat the signal intensities B^{αn} of the respective wavelengths as being uncorrelated and equivalent. Therefore, even if the same image reconstruction processing as that in the conventional single-wavelength GI as will be described below is applied to the detection signal intensity B^{αn} of the multi-wavelength GI, the image of the sample (object) S cannot be reconstructed, in general.

Note that the symbol Δ in Equations (2), (3), and (4) below represents a meaning of taking a difference between the respective signals.

Equation (2) takes a difference between the signal intensities B^{αn} in the respective detections and an average value of the signal intensities B^{αn} in the respective detections, for the signal intensity B^{αn} in the respective detections.

$$Δ {B}^{n} = {B}^{n} - {〈 {B}^{n} 〉}_{n} \qquad ( 2 )$$

Equation (3) takes a difference between the two-dimensional pattern lights E^{αnk} in the respective detections and an average value of the two-dimensional pattern lights E^{αnk} in the respective detections, for the two-dimensional pattern light E^{αnk} corresponding to the respective detections.

$$Δ {E}^{α n k} = {E}^{α n k} - {〈 {E}^{α n k} 〉}_{n} \qquad ( 3 )$$

Equation (4) is an equation for obtaining a reconstructed image G of the sample S of the conventional single-wavelength GI.

$${G}^{k} ≡ {〈 {〈 Δ {B}^{α n} Δ {E}^{α n k} 〉}_{n} 〉}_{α} \qquad ( 4 )$$

In Equation (4), in the conventional single-wavelength GI, the two-dimensional pattern light (projection pattern) is projected on the sample S, and the intensity of the transmitted or reflected light is detected by a single light receiving element. Thereafter, the correlation with the two-dimensional pattern light (projection pattern) corresponding to the signal at each time is calculated, and the image of the sample S is reconstructed.

As described above, the signal intensity B^{αn} generally has a correlation with the wavelength, and thus, in general, the image of the sample (object) S cannot be reconstructed even if Equation (4) is applied in the multi-wavelength GI. This indicates that C is a proportional coefficient that does not depend on the position k or the wavelength α, and has the meaning shown in Equation (5) below.

$${G}^{k} \neq C {ρ}^{k} \qquad ( 5 )$$

That is, when the same image reconstruction processing as in the conventional single-wavelength GI is applied to the multi-wavelength GI, a result that a function G related to the image reconstruction processing is proportional to a reflectance ρ of the object cannot be obtained. Therefore, in the processing using Equation (4) in the multi-wavelength GI, a good result is not obtained for the reconstructed image G for the sample S.

In the multi-wavelength GI according to the present embodiment, an object image Γ^{k} can be reconstructed from the detection signals of the multi-wavelength GI by using the detection signal (transformed signal) β^{αn} obtained by performing the later-described standardization processing (transformation processing) on the signal intensity B^{αn} of the detected light, and using the transformed signal (standardized signal) ε^{αnk} obtained by performing the later-described standardization processing (transformation processing) on the two-dimensional pattern light E^{αnk}. Specifically, the object image Γ^{k} can be reconstructed from the detection signal intensity B^{αn} by using Equations (6), (7), and (8).

Equation (6) takes a difference between the transformed signals β^{αn} obtained by performing the standardization processing on the signal intensities B^{αn} in the respective detections and an average value of the transformed signals β^{αn} obtained by performing the standardization processing on the signal intensities B^{αn} in the respective detections, for the transformed signals β^{αn} obtained by performing the standardization processing (transformation processing) on the signal intensities B^{αn} in the respective detections.

$$Δ {β}^{α n} = {β}^{α n} - {〈 {β}^{α n} 〉}_{n} \qquad ( 6 )$$

Equation (7) takes a difference between the transformed signal ε^{αnk} obtained by performing the standardization processing on the two-dimensional pattern lights E^{αnk} in the respective detections and an average value of the transformed signals ε^{αnk} obtained by performing the standardization processing on the two-dimensional pattern lights E^{αnk} in the respective detections, for the transformed signals (standardized signals) ε^{αnk} obtained by performing the standardization processing (transformation processing) on the two-dimensional pattern lights E^{αnk} corresponding to the respective detections.

$${Δε}^{α n k} = {ε}^{α n k} - {〈 {ε}^{α nk} 〉}_{n} \qquad ( 7 )$$

Equation (8) is an equation for obtaining the reconstructed image Γ^{k} of the sample S of the multi-wavelength GI. That is, “Γ^{k} (gamma)” represents a function related to the image reconstruction processing of the multi-wavelength GI.

$${Γ}^{k} ≡ {〈 {〈 Δ {β}^{α n} {Δε}^{α nk} 〉}_{n} 〉}_{α} = C {ρ}^{k} \qquad ( 8 )$$

However, Equation (8) assumes that the reflectance ρ of the sample (object) S does not depend on the wavelength α.

Next, the standardization processing (transformation processing) of the detection signal intensity B^{αn} detected by the detector 16 will be described. In the multi-wavelength GI using the optical measurement apparatus 10 according to the present embodiment, the pattern light E^{αnk} is projected on the sample S, and the detection signal intensity B^{αn} of the transmitted light or reflected light for each of, for example, the wavelengths (W1, W2 and W3) of R, G, and B from the sample S is detected by, for example, one pixel of the detector 16. However, since the detection signal intensity B^{αn} has a correlation depending on the wavelength characteristic of each detector 16 as described above, the detection signal intensities B^{αn} of the respective wavelengths are not equivalent (see FIG. 5).

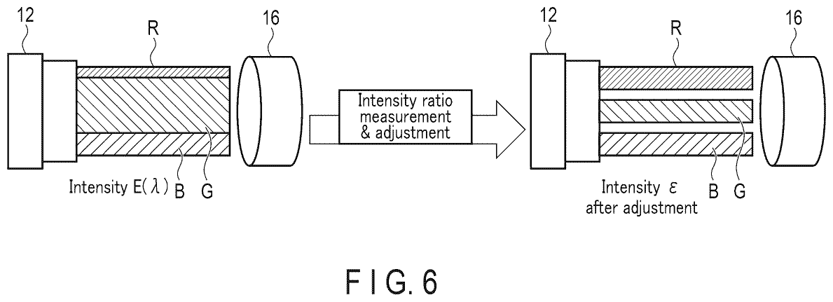

In order to solve such a problem, in general, in many cases, the intensity of each of the wavelengths (e.g. R, G, and B) from the light source of the illumination unit 12 incident on the detector 16 is measured, then the intensity of each wavelength from the light source is adjusted, and an intensity ratio for each wavelength emitted from the light source of the illumination unit 12 is made constant, for example, when detected by a certain detector 16, as illustrated in FIG. 6. However, for such adjustment, a light source capable of adjusting the intensity for each wavelength is essential as the illumination unit 12, and further, it is necessary to adjust the intensity ratio again each time the sample S is changed. Therefore, there are problems such as restrictions on the experimental apparatus and complicated setup.

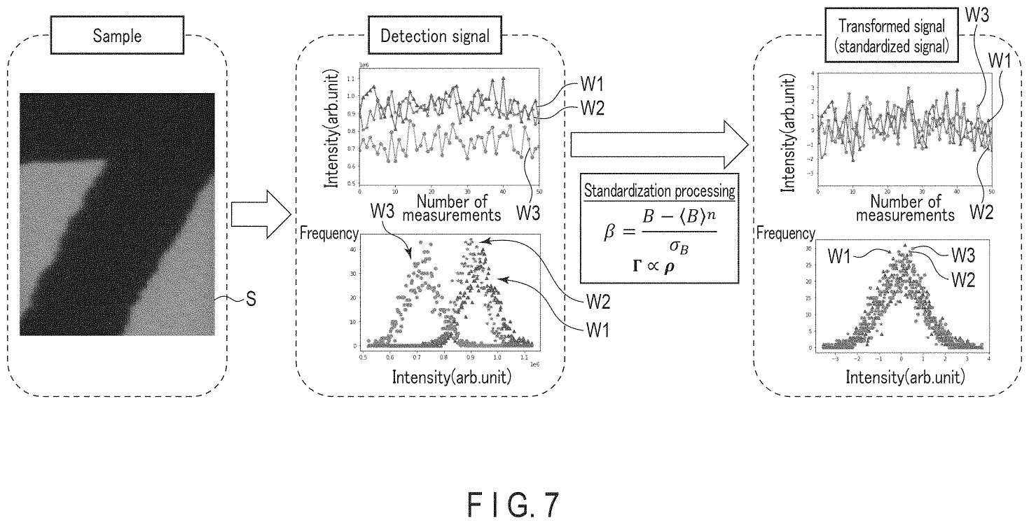

FIG. 7 illustrates the sample S, the detection signal, and the transformed signal (standardized signal). The detection signal shows the detection signal intensity B^{αn} detected by the detector 16 and a histogram regarding the detection signal intensity B^{αn} before performing the standardization processing on the detection signal intensity B^{αn}. In addition, the transformed signal (standardized signal) shows a signal intensity and a histogram regarding the transformed signal β^{αn} after performing the standardization processing on the detection signal intensity B^{αn}. As illustrated in FIG. 7, the distributions of the respective wavelengths of the signals β^{αn} can be roughly matched by performing the standardization processing of the detection signal intensities B^{αn}. Such substantial matching of the distributions of the respective wavelengths of the transformed signals β^{αn} means that the transformed signals β^{αn} of the respective wavelengths obtained by performing the standardization processing of the detection signal intensities B^{αn} are uncorrelated and equivalent. The point here is that the transformed signal β^{αn} of each wavelength obtained by performing the standardization processing of the detection signal intensity B^{αn} is a signal obtained by processing after measuring the detection signal intensity B^{αn}, and it is not necessary to measure or adjust the intensity ratio of the light source of the illumination unit 12 in advance.

As described above, in the processing apparatus 18 of the optical measurement apparatus 10 according to the present embodiment, the signals of the respective wavelengths can be treated as being substantially equivalent transformed signals β^{αn} by performing the standardization processing (transformation processing) on the detection signal intensities B^{αn}. In the multi-wavelength GI, the transformed signals β^{αn} that can be treated as being equivalent are used instead of the detection signal intensities B^{αn}.

Here, the standardization processing of the transformed signal β^{αn} refers to transformation processing as represented by Equation (9) below using an ensemble average <β^{αn}> of the detection signal B^{αn} and a standard deviation σ_{B}^{α} of the detection signal intensity B^{αn}. Such transformation processing (first transformation processing) is equivalent to performing transformation processing of numerical values (intensity values B^{αn} of the detection signals) using independent parameters for the respective wavelengths with respect to the intensity values B^{αn} of the detection signals, and setting the transformed numerical values as first transformed signals β^{αn} corresponding to the respective wavelengths.

$${β}^{α n} = \frac{{B}^{α n} - {〈 {B}^{α n} 〉}_{n}}{{σ}_{B}^{α}} \qquad ( 9 )$$

Here, similarly, ε^{αnk} obtained by standardizing a pattern light intensity E^{αnk} is defined. The distributions of the respective wavelengths of the transformed signals ε^{αnk} are approximately matched by performing the standardization processing of the pattern light intensity B^{αnk}. Such substantial matching of the distributions of the respective wavelengths of the transformed signals ε^{αnk} means that the transformed signals ε^{αnk} of the respective wavelengths obtained by performing the standardization processing of the pattern light intensities ε^{αnk} are uncorrelated and equivalent. The point here is that the transformed signal ε^{αnk} of each wavelength obtained by performing the standardization processing of the pattern light intensity E^{αnk} is a signal obtained by processing after projecting the pattern light (projection light), and it is not necessary to measure or adjust the intensity ratio of the light source of the illumination unit 12 in advance.

In the processing apparatus 18 of the optical measurement apparatus 10 according to the present embodiment, the signals of the respective wavelengths can be treated as being substantially equivalent transformed signals ε^{αnk} by performing the standardization processing (second transformation processing) on the pattern light intensities E^{αnk} which are signals regarding the respective projection lights obtained from the illumination unit 12. In the multi-wavelength GI, the transformed signals ε^{αnk} that can be treated as being equivalent are used instead of the pattern light intensities E^{αnk}.

Here, the standardization processing of the transformed signal ε^{αnk} refers to transformation processing as represented by Equation (10) below using an ensemble average <E^{αnk}>ₙ of the pattern light intensity E^{αnk} and a standard deviation σ_{E}^{αk} of the pattern light intensity E^{αnk}. Such transformation processing (second transformation processing) is equivalent to performing transformation processing of numerical values (pattern light intensities E^{αnk}) using independent parameters for the respective wavelengths with respect to the pattern light intensities E^{αnk}, and setting the transformed numerical values as second transformed signals ε^{αnk} corresponding to the respective wavelengths.

$${ε}^{α nk} = \frac{{E}^{a n k} - {〈 {E}^{α nk} 〉}_{n}}{{σ}_{E}^{α k}} \qquad ( 10 )$$

As described above, the function δ^{k} of the reconstruction processing represented by Equation (8) can be in a relationship proportional to the reflectance distribution ρ^{k} of the sample S by defining the transformed signal β^{αn} obtained by performing the standardization processing of the detection signal intensity B^{αn} and the transformed signal ε^{αnk} obtained by performing the standardization processing of the pattern light intensity E^{αnk}.

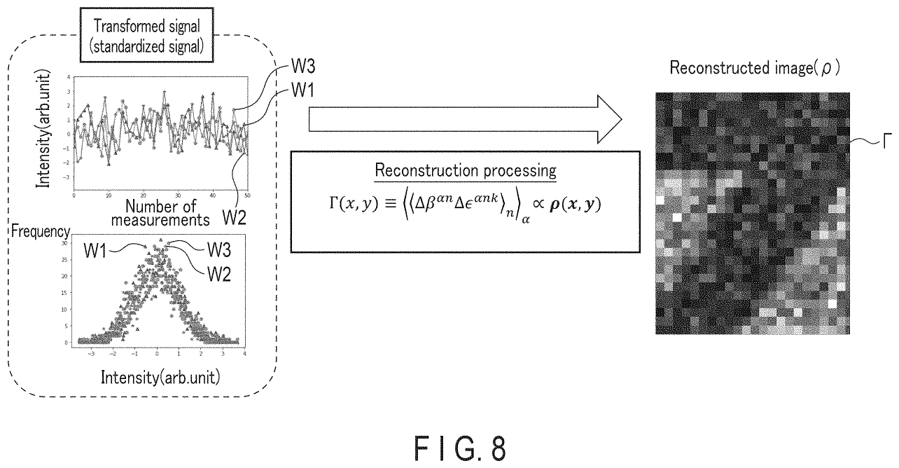

This indicates that, as illustrated in FIG. 8, when the object image is reconstructed from the detection signal intensity β^{αn}, the use of the transformed signals β^{αn} and ε^{αnk} subjected to the standardization processing enables this equation to be handled similarly as in the equation in which the function G of the reconstruction processing is proportional to the reflectance distribution ρ of the sample S as in Equation (4) of the single-wavelength GI known in the related art.

Therefore, in the multi-wavelength GI according to the present embodiment, the reflectance distribution ρ^{k} of the sample S, that is, the image of the multi-wavelength GI of the sample S can be acquired by inputting the transformed signal β^{αn} subjected to the standardization processing so that the signals of the respective wavelengths of the detection signal intensities B^{αn} can be treated as being equivalent and the transformed signal ε^{αnk} subjected to the standardization processing so that the signals of the respective wavelengths of the pattern light intensities E^{αnk} can be treated as being equivalent, into the function δ^{k} of the reconstruction processing represented by Equation (8).

Therefore, the transformed signals β^{αn} and ε^{αnk} are applied to Equation (8), thereby obtaining an image (reconstructed image) proportional to the function Γ^{k}, that is, the reflectance ρ^{k} of the sample S of the multi-wavelength GI. At this time, when products of the transformed signals (first transformed signals) β^{αn} transformed from the intensity values of the detection signals acquired by the detector 16 and the transformed signals (second transformed signals) ε^{αnk} transformed from signals regarding a plurality of projection lights are referred to as pixel products, the function Γ^{k} involves performing processing of calculating an average value of the pixel products.

It is clear that, in the image (see FIG. 8) reconstructed using the processing apparatus 18 of the optical measurement apparatus 10 according to the present embodiment, the state of the sample S (see FIG. 7) can be reconstructed more than that in the reconstructed image by the conventional method in the multi-wavelength GI using three wavelengths (see FIG. 5). Therefore, it can be seen that the standardized signals β^{αn} and ε^{αnk} are obtained from the detection signals B^{αn} and E^{αn} of the multi-wavelength GI by using the optical measurement apparatus 10 according to the present embodiment, and that the image δ^{k} of the sample S can be reconstructed by the standardized signals β^{αn} and ε^{αnk}. That is, it can be said that the use of the optical measurement apparatus 10 according to the present embodiment can realize the speed-up of the GI due to multi-wavelength.

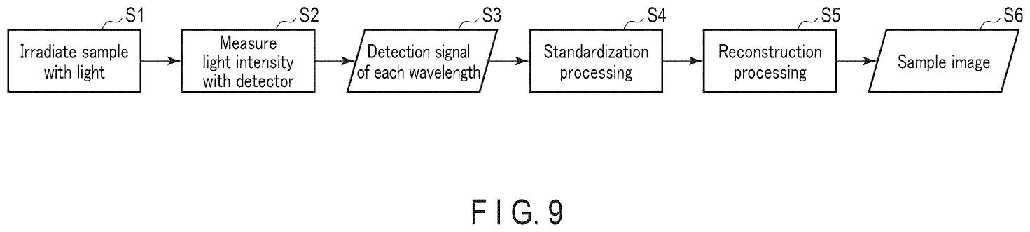

The processing apparatus 18 of the optical measurement apparatus 10 according to the present embodiment can operate along the flow illustrated in FIG. 9.

As illustrated in FIG. 9, the processing apparatus 18 projects a plurality of different projection lights including a plurality of different wavelengths toward the sample S (step S1).

The processing apparatus 18 causes the detector 16 to acquire the detection signal intensities (intensity values) B^{αn} of the lights of the wavelengths from the sample S by the projection of the respective projection lights as detection signals having no information regarding position at a stage of processing each signal (step S2). Furthermore, the processing apparatus 18 causes a signal to be acquired related to the projection light to be projected onto the sample S at each time from the illumination unit 12.

The processing apparatus 18 obtains a detection signal of each wavelength (step S3). At this time, the processing apparatus 18 acquires the detection signal intensity B^{αn} for each of N measurements. Note that the processing apparatus 18 may acquire the signal related to the projection light to be projected from the illumination unit 12 onto the sample S at each time.

The processing apparatus 18 performs the standardization processing (first transformation processing) on the detection signal intensity B^{αn} to obtain the transformed signal (first transformed signal) β^{αn}, and performs the standardization processing (second transformation processing) on the pattern light intensity E^{αnk} to obtain the transformed signal (second transformed signal) ε^{αnk} (step S4).

The processing apparatus 18 inputs the transformed signal (first transformed signal) β^{αn} and the transformed signal (second transformed signal) ε^{αnk} in the function δ^{k} of Equation (8), and performs reconstruction processing of the sample S (step S5). That is, the processing apparatus 18 calculates the correlation between the first transformed signal β^{αn} transformed by performing the standardization processing (first transformation processing) on the detection signal intensity B^{αn} and the second transformed signal ε^{αnk} transformed by performing the standardization processing (second transformation processing) on the pattern light intensity E^{αnk}, and performs reconstruction processing of the sample S.

In this way, the processing apparatus 18 obtains an image of the sample S by the function δ^{k} of Equation (8) (step S6).

As described above, the processing apparatus (processing unit) 18 of the optical measurement apparatus 10 according to the present embodiment cause a plurality of different projection lights to be projected onto the sample (object) S. The projection lights respectively include a plurality of different wavelengths. Then, the processing apparatus 18 causes the intensity values of the plurality of wavelengths to be acquired from the sample S for each the projection lights, as intensity values of the detection signals having no information regarding position at the stage of processing the signals. The processing apparatus 18 transforms (for example, standardization processes) numerical values of the intensity values using independent parameters for each of the wavelengths to first transformed signals (for example, standardized signals) corresponding to the plurality of wavelengths from the sample S. Furthermore, the processing apparatus 18 transforms (for example, standardization processes) the signals related to the projection lights projected on the sample S to second transformed signals (for example, standardized signals) corresponding to the plurality of wavelengths from the projection lights. The processing apparatus 18 causes an image of the sample S to be acquired by first transformed signals (for example, first standardized signals) corresponding to the plurality of wavelengths from the sample S and second transformed signals (for example, standardized signals) as signals related to the projection lights.

The optical measurement method according to the present embodiment is performed along the processing of the processing apparatus 18 described above. The optical measurement method includes: causing a plurality of different projection lights to be projected onto an object, the projection lights respectively including a plurality of wavelengths different from each other; causing intensity values of the plurality of wavelengths to be acquired from the object for each of the projection lights, as intensity values of detection signals having no information regarding position at a stage of processing signals; transforming numerical values of the detection signals using independent parameters for each of wavelengths to first transformed signals corresponding to the plurality of wavelengths from the object; and causing an image of the object to be acquired by the first transformed signals corresponding to the plurality of wavelengths from the object and signals related to the projection lights.

The optical measurement program according to the present embodiment is performed along the processing of the processing apparatus 18 described above. The optical measurement program causes a computer to execute: causing a plurality of different projection lights to be projected onto an object, the projection lights respectively including a plurality of wavelengths different from each other; cause intensity values of the plurality of wavelengths to be acquired from the object for each of the projection lights, as intensity values of detection signals having no information regarding position at a stage of processing signals; transforming numerical values of the detection signals using independent parameters for each of wavelengths to first transformed signals corresponding to the plurality of wavelengths from the object; and cause an image of the object to be acquired by the first transformed signals corresponding to the plurality of wavelengths from the object and signals related to the projection lights.

Therefore, the use of the processing apparatus 18 of the optical measurement apparatus 10 according to the present embodiment makes it possible to project lights of a plurality of wavelengths onto the sample (object) S and to acquire an image of the sample S from a detection signal of each light intensity. The optical measurement apparatus 10 according to the present embodiment can reconstruct the image of the sample (object) S from signals of a plurality of wavelengths acquired in the multi-wavelength GI. Therefore, according to the present embodiment, it is possible to provide the optical measurement apparatus 10, an optical measurement method, and optical measurement, which are configured to cause a plurality of wavelengths to be projected onto the sample (object) S and to cause an image of the sample S to be acquired from detection signals of each of light intensities.

At this time, the optical measurement apparatus 10 can acquire a plurality of signals by one signal detection, and thus the optical measurement apparatus 10 can shorten the acquisition time in the case of acquiring the same number of signals as compared with the case of acquiring the image of the sample S by sequentially projecting pattern light of a single wavelength having no correlation on the sample S. Therefore, the use of the optical measurement apparatus 10 according to the present embodiment makes it possible to effectively utilize signals of the respective different wavelengths and to realize speed-up of the multi-wavelength GI.

Then, in a case where the optical measurement apparatus 10 according to the present embodiment is used, the transformed signal ε^{αnk} of each wavelength obtained by performing the standardization processing on the pattern light intensity E^{αnk} is a signal obtained by the processing after the measurement of the pattern light intensity E^{αnk}. Therefore, it is not necessary to measure or adjust the intensity ratio of the light source of the illumination unit 12 in advance. Therefore, in a case where the optical measurement apparatus 10 according to the present embodiment is used, it is possible to acquire a reconstructed image due to the multi-wavelength GI using an arbitrary illumination unit 12.

Note that the method of the transformation processing (standardization) can be changed depending on the types of the illumination unit 12 or the sample S, and Formula (9) is merely an example. Equation (9) can be set as in Equation (11) using, for example, the median value m_{B}^{α} of the detection signals B^{αn} in all measurements instead of the ensemble average <β^{αn}>ₙ.

$${β}^{α n} = \frac{{B}^{α n} - {m}_{B}^{α}}{{σ}_{B}^{α}} \qquad ( 11 )$$

In addition, Formula (9) can be set as in Formula (12) using, for example, the ensemble average <β^{αn}>ₙ and the mode value M_{B}^{α} of the detection signals B^{αn} in all measurements.

$${β}^{α n} = \frac{{B}^{α n} - {M}_{B}^{α}}{{σ}_{B}^{α}} \qquad ( 12 )$$

In addition, Equation (9) can be set as in Equation (13) using the variance V_{B}^{α} of the detection signal intensity B^{αn} instead of the standard deviation σ_{B}^{α}.

$${β}^{α n} = \frac{{B}^{α n} - {〈 {B}^{α n} 〉}_{n}}{\sqrt{{V}_{B}^{α}}} \qquad ( 13 )$$

Therefore, when performing transformation processing of the numerical values of the intensity values B^{αn} using independent parameters for the respective wavelengths with respect to the intensity values B^{αn} of the detection signals and setting the transformed numerical values as the transformed signals β^{αn} corresponding to at least two different wavelengths, the processing apparatus 18 can handle the transformed signals β^{αn} of the respective wavelengths as being uncorrelated and equivalent. Then, the processing apparatus 18 can handle the transformed signals β^{αn} of the respective wavelengths as being uncorrelated and equivalent by performing processing of transforming the intensity values B^{αn} of the detection signals using statistical information as such transformation processing. Then, the statistical information on the intensity values B^{αn} of the detection signals includes at least one piece of information related to an average value (ensemble average)<B^{αn}>ₙ, a median value m_{B}^{α}, a mode value M_{B}^{α}, a variance value V_{B}^{α}, and a standard deviation σ_{B}^{α} of the intensity values B^{αn} of the detection signals.

This can be applied not only to the intensity values B^{αn} of the detection signals but also to (illuminances of) two-dimensional pattern lights E^{αnk}. That is, the processing apparatus 18 can handle the transformed signals ε^{αnk} of the respective wavelengths as uncorrelated and equivalent by performing processing of transforming (illuminances of) the two-dimensional pattern lights E^{αnk} using statistical information as the transformation processing.

Furthermore, in a case where a light source in which the pixel values of the input data (projection lights) and the pattern light intensities (illuminances of the output lights) E^{αnk} have a linear relationship is used as the illumination unit 12, the input data on the illuminances E^{αnk} can be treated as the signals ε^{αnk} subjected to the standardization processing by setting an appropriate pattern as the input data (projection lights). That is, in a case where such a light source is used as the illumination unit 12, it is necessary that the pattern lights should be uncorrelated, but processing can be performed while the respective wavelengths are treated as being equivalent. However, in a case of obtaining a reconstructed image of the multi-wavelength GI, there may be a case where the standardization processing (transformation processing) of input signals E^{αnk} of the projection pattern lights becomes unnecessary. By using a projector as an example of the light source of the illumination unit 12, transformation processing of the pattern light intensities (illuminances of the output lights) E^{αnk} may be unnecessary.

Therefore, the processing apparatus (processing unit) 18 of the optical measurement apparatus 10 according to the present embodiment causes a plurality of different projection lights to be projected onto the sample (object) S. The projection lights respectively include a plurality of wavelengths different from each other. Then, the processing apparatus 18 causes the intensity values of the plurality of wavelengths to be acquired from the sample S for each of the projection lights, as intensity values of the detection signals having no information regarding position at the stage of processing the signals. The processing apparatus 18 transforms (for example, standardization processes) numerical values of the intensity values of the detection signals using independent parameters for each of wavelengths to first transformed signals (for example, standardized signals) corresponding to the plurality of wavelengths from the sample S. The processing apparatus 18 causes an image of the sample S to be acquired by the first transformed signals (for example, first standardized signals) corresponding to the plurality of wavelengths from the sample S and signals related to the projection lights.

According to the processing apparatus 18, the optical measurement apparatus 10, the optical measurement method, and the optical measurement program of at least one embodiment described above, it is possible to project lights of a plurality of wavelengths on an object (sample) S and to acquire an image of the object from detection signals (light intensity values) of the respective light intensities.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing apparatus comprising a processor configured to:
cause a plurality of different projection lights to be projected onto an object, the projection lights respectively including a plurality of wavelengths different from each other;
cause intensity values of the plurality of wavelengths to be acquired from the object for each of the projection lights, as intensity values of detection signals having no information regarding position at a stage of processing signals;
transform numerical values of the intensity values of the detection signals using independent parameters for each of wavelengths to first transformed signals corresponding to the plurality of wavelengths from the object; and
cause an image of the object to be acquired by the first transformed signals corresponding to the plurality of wavelengths from the object and signals related to the projection lights.

2. The processing apparatus according to claim 1, wherein when the processor coverts the intensity values of the detection signals to the first transformed signals, the processor is configured to perform the transformation processing using statistical information on the intensity values of the detection signals.

3. The processing apparatus according to claim 2, wherein the statistical information on the intensity values of the detection signals include at least one piece of information related to an average value, a median value, a mode value, a variance value, and a standard deviation of the intensity values of the detection signals.

4. The processing apparatus according to claim 1, wherein:
the processor is configured to transform numerical values of intensity values of a plurality of wavelengths of the projection lights projected toward the object using independent parameters for each of the plurality of wavelengths of the projection lights to second transformed signals corresponding to the plurality of wavelengths of the projection lights, and
the processor is configured to cause the image of the object to be acquired by the first transformed signals and the second transformed signals when the processor acquires the image of the object.

5. The processing apparatus according to claim 4, wherein when the processor acquires the image of the object by the first transformed signal and the second transformed signal, the processor is configured to:
set at least products of the first transformed signals and the second transformed signals as pixel products, and
calculate an average value of the pixel products.

6. An optical measurement apparatus comprising:
the processing apparatus according to claim 1;
an illumination unit configured to project the projection lights toward the object; and
a detector configured to acquire the detection signal.

7. The optical measurement apparatus according to claim 6, wherein:
the illumination unit is controlled by the processing apparatus, and
the projection lights projected toward the object have spatial intensity distributions.

8. An optical measurement method comprising:
causing a plurality of different projection lights to be projected onto an object, the projection lights respectively including a plurality of wavelengths different from each other;
causing intensity values of the plurality of wavelengths to be acquired from the object for each of the projection lights, as intensity values of detection signals having no information regarding position at a stage of processing signals;
transforming numerical values of the intensity values of the detection signals using independent parameters for each of wavelengths to first transformed signals corresponding to the plurality of wavelengths from the object; and
causing an image of the object to be acquired by the first transformed signals corresponding to the plurality of wavelengths from the object and signals related to the projection lights.

9. A non-transitory storage medium storing an optical measurement program, the optical measurement program causing a computer to execute:
causing a plurality of different projection lights to be projected onto an object, the projection lights respectively including a plurality of wavelengths different from each other;
causing intensity values of the plurality of wavelengths to be acquired from the object for each of the projection lights, as intensity values of detection signals having no information regarding position at a stage of processing signals;
transforming numerical values of the intensity values of the detection signals using independent parameters for each of wavelengths to first transformed signals corresponding to the plurality of wavelengths from the object; and
causing an image of the object to be acquired by the first transformed signals corresponding to the plurality of wavelengths from the object and signals related to the projection lights.
